(19) United States
(12) Patent Application Publication
(10) Pub. No.: US 2006/0056069 A1
(43) Pub. Date: Mar. 16, 2006

(54) Photographic lens with fixed focal length

(75) Inventor: Benky Kao, Taipei City (TW)

Correspondence Address: TROXELL LAW OFFICE PLLC, SUITE 1404, 5205 LEESBURG PIKE, FALLS CHURCH, VA, 22041, US

(73) Assignee: Premier Image Technology Corporation

(21) Appl. No.: 10/937,250

(22) Filed: Sep. 10, 2004

(51) Int. Cl. G02B 9/14

(52) U.S. Cl. 359/785

(57) ABSTRACT

A photographic lens with fixed focal length has a first lens element having a positive optical performance, a second lens element having a negative optical performance and a third lens element having a positive optical performance, in order from object side to image side. The first lens element is made of an acrylic material. The second lens element is made of a polycarbonate material. The third lens element is made of a poly-olefin resin (ZEONEX) material. Furthermore, it can be achieved to reduce the brightness attenuation of the periphery of the lens and the image variation of the lens element when the temperature changes.

### BACKGROUND OF THE INVENTION

1. Field of the Invention

The present invention relates to a photographic lens with a fixed focal length and, more particularly to a photographic lens for raising the brightness of the periphery of a lens and reducing the sensitivity thereof to temperature changes.

2. Description of the Related Art

Recently, digital cameras adapted for electronic devices, such as portable telephones, personal digital assistants (PDAs), etc., have also been miniaturized along with the trend to miniaturize electronic devices. Therefore, many photographic lenses used in these small electronic devices also emphasize smallness and portability and are constructed with only one or two lens elements. Accordingly, the further development of the photographic lenses, such that they are small, cheap and high in performance, is desired.

Reference is made to FIG. 1, which shows a conventional photographic lens adapted for a digital camera. The photographic lens provided by two-piece construction includes, in order from object side to image side, a first lens element 10a having a positive optical performance and two aspherical surfaces, and a second lens element 20a having a positive optical performance and two aspherical surfaces and with its convex surface on the image side. The first positive lens element 10a is made of a poly-olefin resin (ZEONEX) material. The second positive lens element 20a is made of an acrylic material. In FIG. 1, the conventional two-piece construction of photographic lens has an incident angle of 35 degrees in that light is focused on the image face through two lens element 10a, 20a of the positive optical performances. The aspherical surfaces has a shape that is defined by the following feature of the two lens elements 10a, 20a:

$$\frac{F2}{I2} ≅ 1.815$$

$$\begin{matrix}\frac{F2}{f4} ≅ 0.940 ; \\ \frac{F2}{f5} ≅ 0.169\end{matrix}$$

where
1.49<Nd<1.59; 29<Vd<58;
F2 is an effective focal length;
f4 is a focal length of the first lens element 10a;
f5 is a focal length of the second lens element 20a; and
I2 is a maximum image height.

Table 1 below lists the surface number #, in order from the object side, the radius of curvature. R (mm) near the optical axis of each surface, the on-axis distance D (mm) between surfaces, and the index of refraction Nd and Abbe number Vd of the optical material of the lens elements.

TABLE 1

| # | R | D | Nd/Vd |
|---|---|---|---|
| 11a | 1.187773 | 1.156 | 1.51512/57.15 |
| 12a | 1.67264 | 0.542 | |
| 21a | −56.80634 | 0.875 | 1.50176/57.44 |
| 22a | −9.871755 | 0.104 | |

Aspherical Surface 12a:

| | |
|---|---|
| Conic: | 2.987802 |
| Coeff on r 4: | 0.110177 |
| Coeff on r 6: | −0.793024 |
| Coeff on r 8: | 3.178125 |
| Coeff on r 10: | −4.037481 |

Aspherical Surface 21a:

| | |
|---|---|
| Conic: | −2508497 |
| Coeff on r 4: | −0.160239 |
| Coeff on r 6: | 0.164632 |
| Coeff on r 8: | −0.37081561 |
| Coeff on r 10: | 0.25373612 |

Aspherical Surface 22a:

| | |
|---|---|
| Conic: | −1359.255 |
| Coeff on r 4: | −0.090137 |
| Coeff on r 6: | 0.0058453443 |
| Coeff on r 8: | 0.0013537382 |
| Coeff on r 10: | −0.00731 |

Further, FIGS. 1A-1G show aberrations of the conventional photographic lens, with FIG. 1A showing the longitudinal aberration, FIG. 1B showing the lateral color, FIG. 1C showing the curvature field, FIG. 1D showing the distortion, FIG. 1E showing the relative illumination, FIG. 1F showing the polychromatic diffraction MTF, and FIG. 1G showing the polychromatic diffraction through focus MTF, accordingly.

However, the conventional photographic lens still has the below disadvantages:

When light is focused on the image face through the lens element 10a, 20a, the brightness of the periphery of the lens will be obviously attenuated compared with that of whole of the lens formed of only two lens elements. Furthermore, because of the material of the only two lens elements, the lens will fail to be balanced relative to the temperature change so as to affect the image performance.

### SUMMARY OF THE INVENTION

It is therefore a principal object of the invention to provide a photographic lens with a fixed focal length having different lens element arrangement for reducing the incident angle of light through the lens elements to image face. Furthermore, the present invention has been accomplished to eliminate the aforesaid problem in that the brightness of the periphery of the lens will be attenuated quickly.

It is therefore another object of the invention to provide a photographic lens with fixed focal length having different materials of lens elements for reducing the image variation of the lens element when the temperature changes.

It is therefore yet another object of the invention to provide a photographic lens formed by means of injection molding to reduce lens size, to mold the lens quickly, to manufacture the lens easily, and reduce costs.

To achieve the above object, the present invention provides a photographic lens with fixed focal length, and the photographic lens includes a first lens element having a positive optical performance, a second lens element having a negative optical performance and a third lens element having a positive optical performance, in order from object side to image side. The first lens element is made of an acrylic material. The second lens element is made of a polycarbonate material. The third lens element is made of a poly-orefin resin (ZEONEX) material. The photographic lens further includes a distance smaller than 5.3 mm between an object-side surface of the first lens element and the image side.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a schematic view of a photographic lens of a prior art;

FIGS. 1A-1G show aberrations of the photographic lens of the prior art, with FIG. 1A showing the longitudinal aberration, FIG. 1B showing the lateral color, FIG. 1C showing the curvature field, FIG. 1D showing the distortion, FIG. 1E showing the relative illumination, FIG. 1F showing the polychromatic diffraction MTF, and FIG. 1G showing the polychromatic diffraction through focus MTF.

FIG. 2 is a schematic view of a photographic lens of the present invention;

FIGS. 2A-2G show aberrations of the photographic lens of the present invention, with FIG. 2A showing the longitudinal aberration, FIG. 2B showing the lateral color, FIG. 2C showing the curvature field, FIG. 2D showing the distortion, FIG. 2E showing the relative illumination, FIG. 2F showing the polychromatic diffraction MTF, and FIG. 2G showing the polychromatic diffraction through focus MTF.

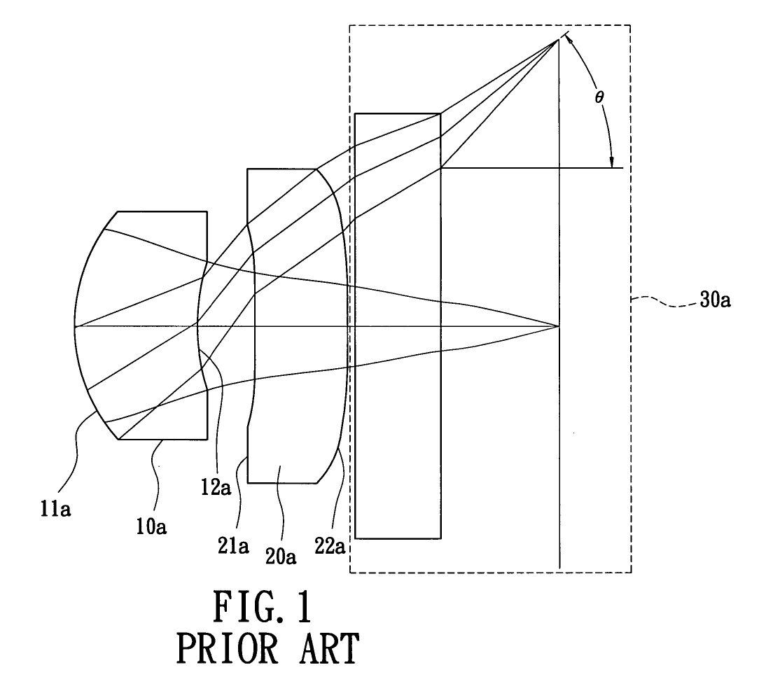

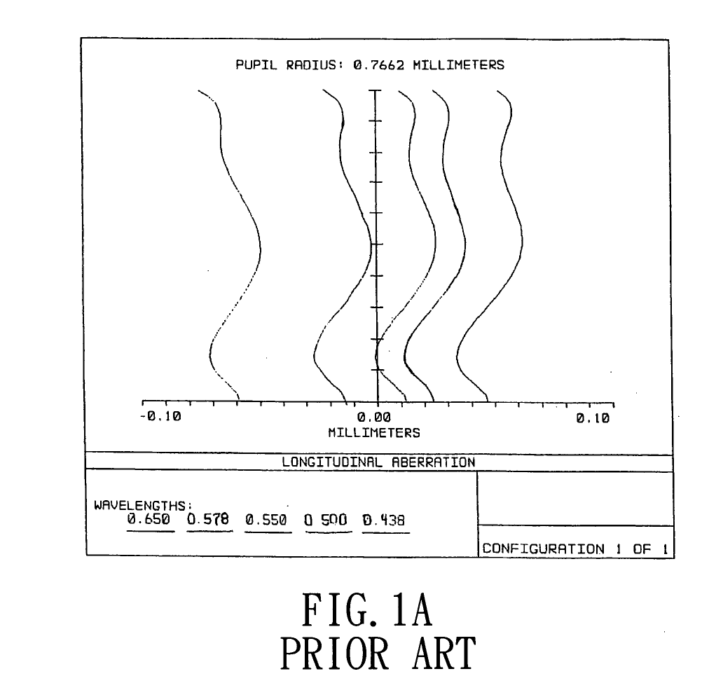

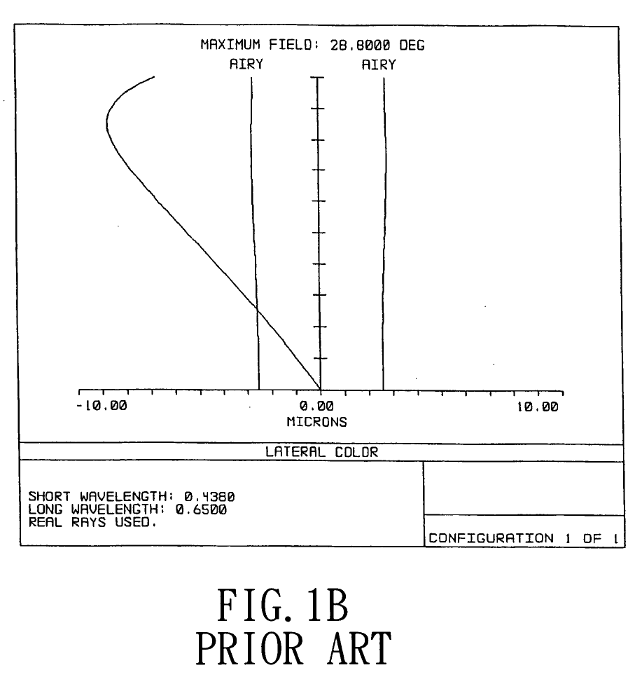

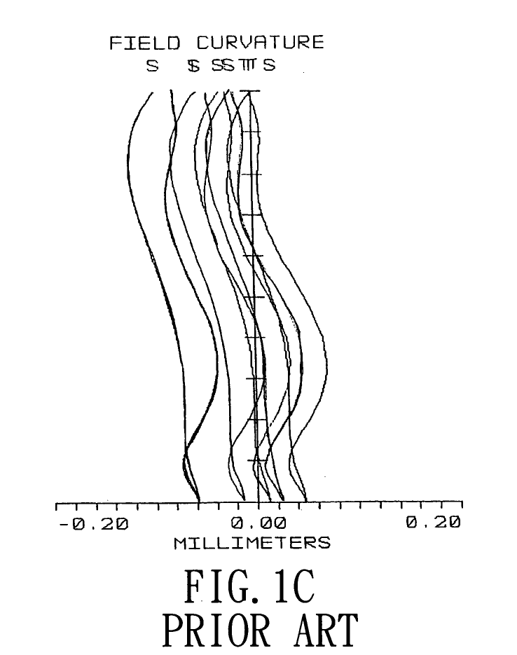

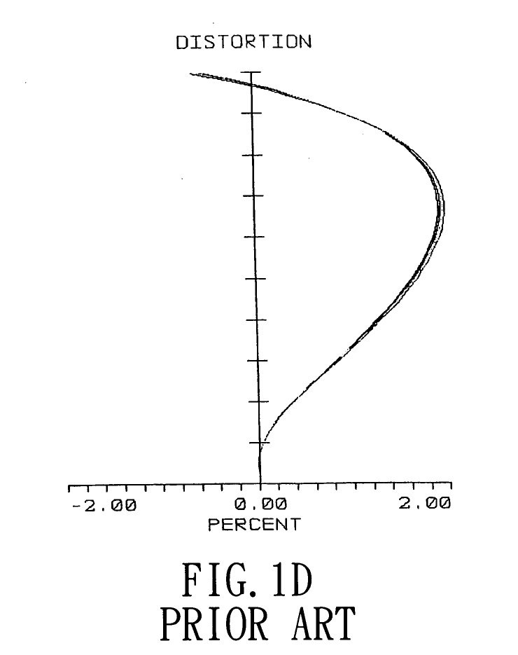

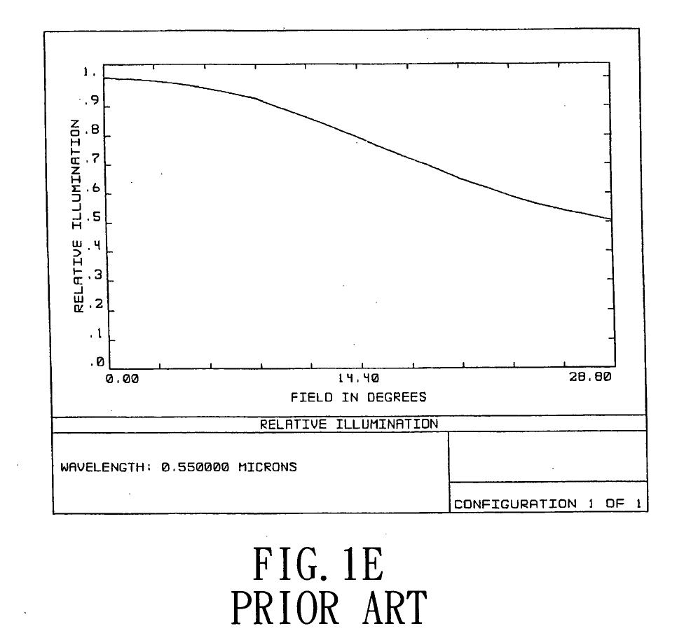

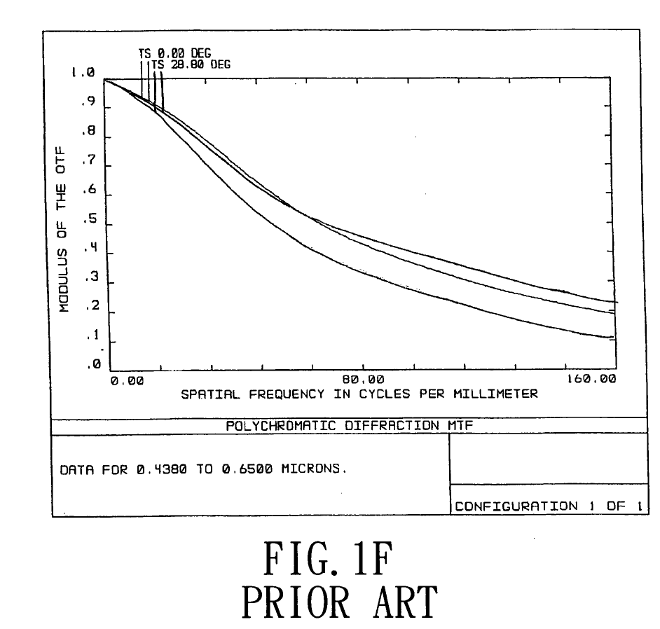

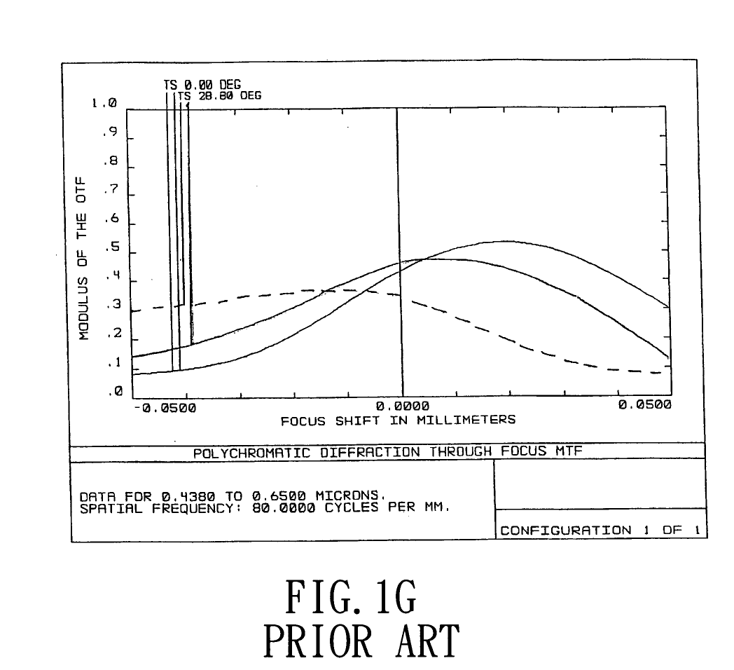

### DETAILED DESCRIPTION OF THE EMBODIMENTS

Wherever possible in the following description, like reference numerals will refer to like elements and parts unless otherwise illustrated.

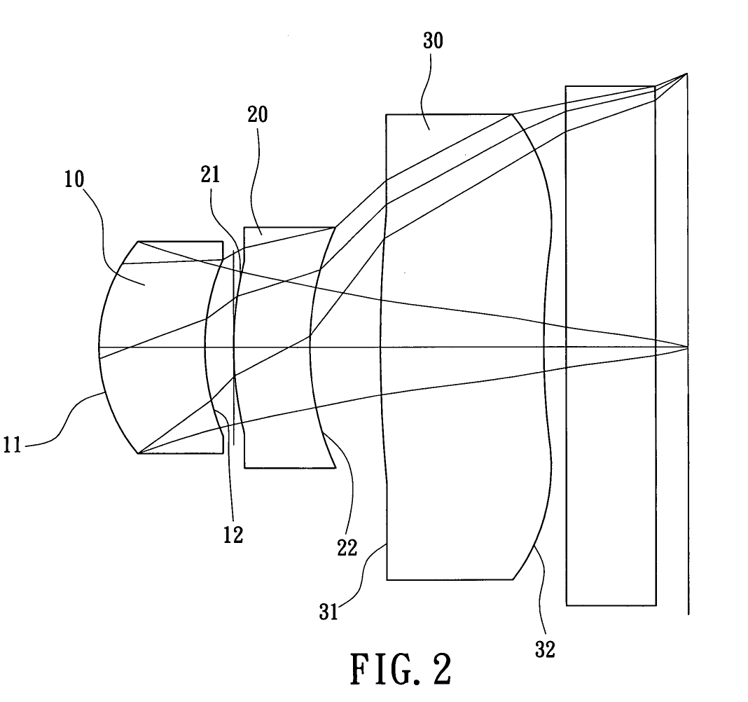

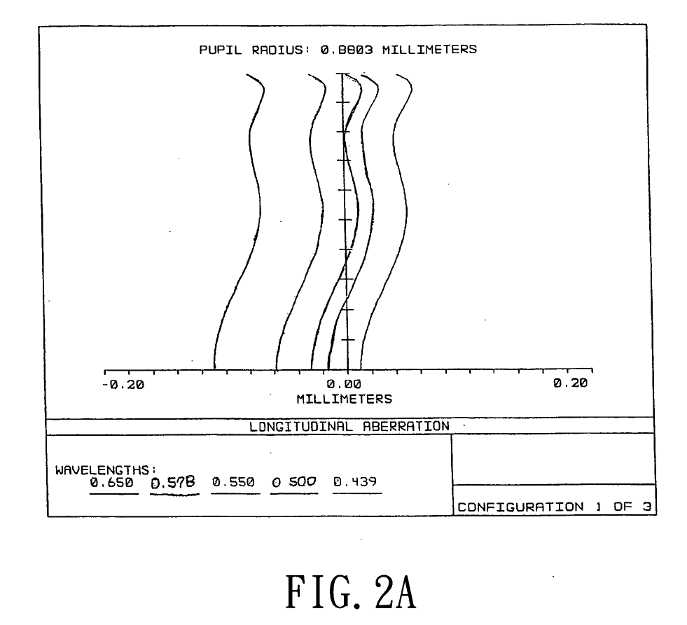

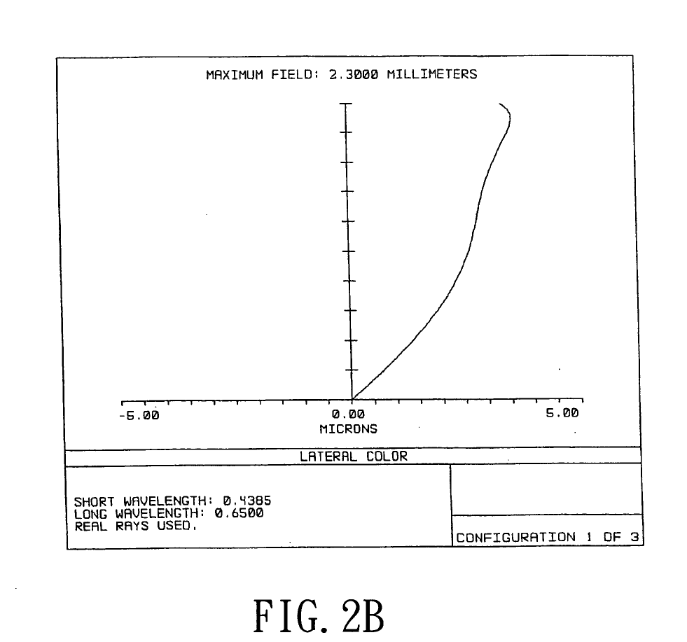

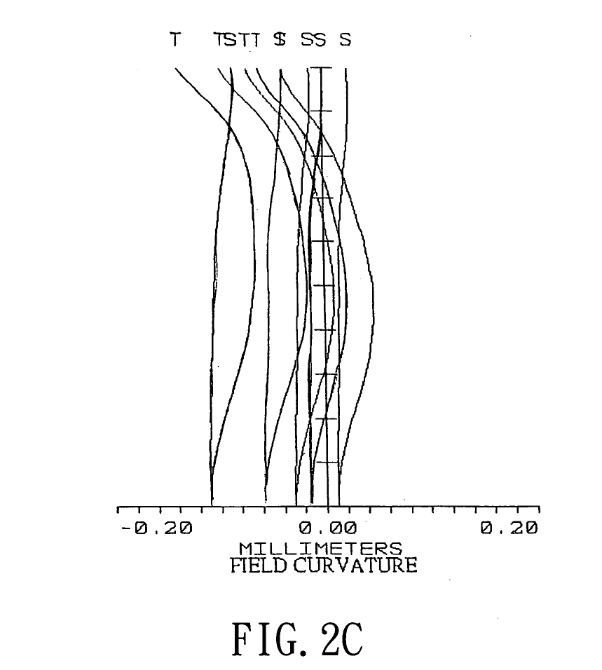

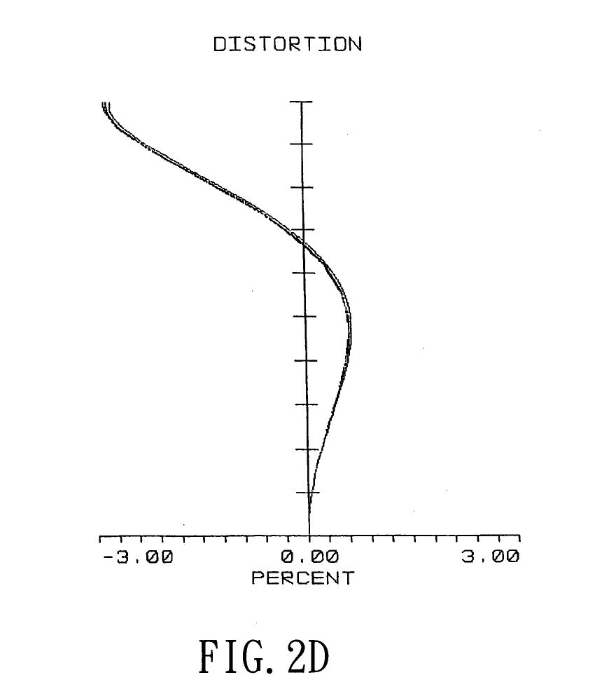

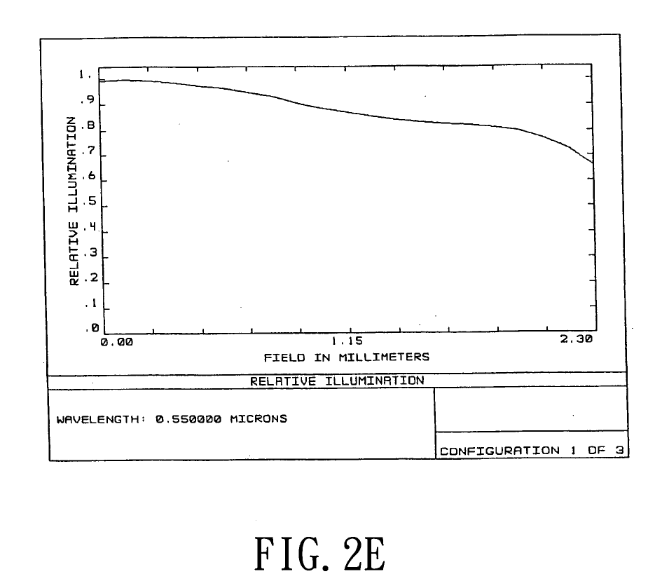

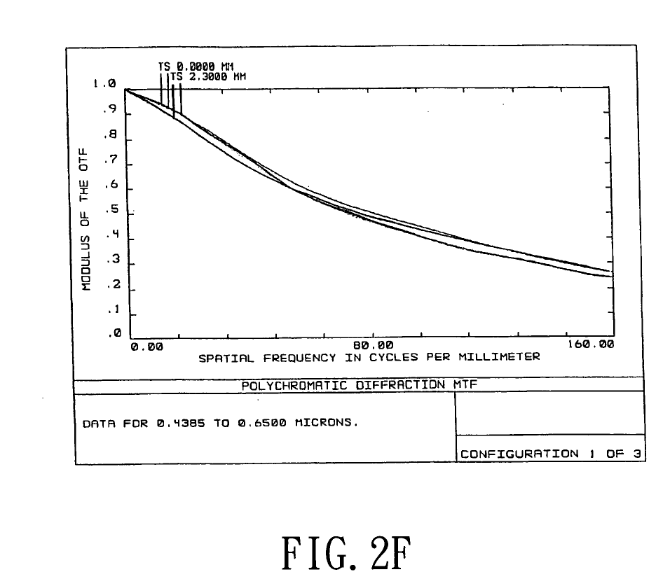

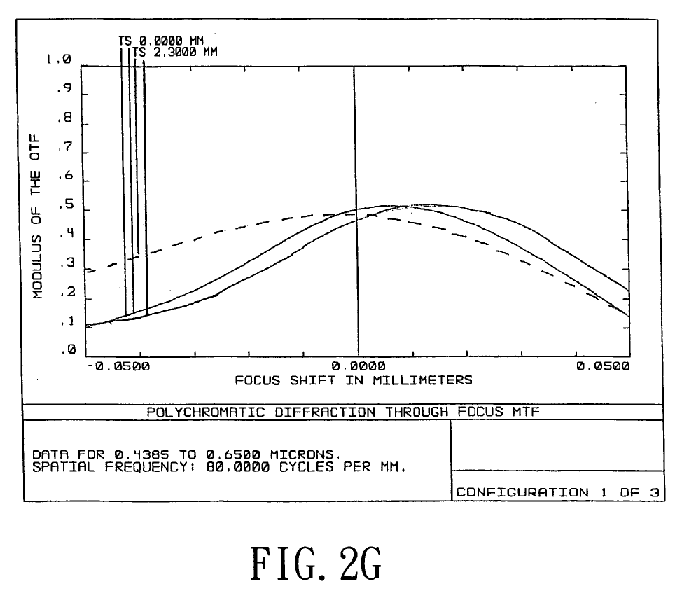

With reference to FIG. 2, the present invention provides a photographic lens with fixed focal length including a first lens element 10 having a positive optical performance, a second lens element 20 having a negative optical performance and a third lens element 30 having a positive optical performance, together constructing a short-focal length of photographic lens for reducing the brightness attenuation on the periphery of the lens and preventing the vignetting phenomenon from being produced on the image face.

Furthermore, a three-piece construction of photographic lens is formed by injection molding utilizing a plastic material. Several advantages, such as, for example, a smaller volume and a simple manufacturing process to reduce costs, are provided by use of this process and material. The first lens element 10 is made of an acrylic material. The second lens element 20 is made of a polycarbonate material. The third lens element 30 is made of a poly-orefin resin (ZEONEX) material. The short-focal length of photographic lens further includes a distance smaller than 5.3 mm between an object-side surface of the first lens element 10 and the image side or image face of the sensitive element 40, which is a complementary metal-oxide semiconductor (CMOS). Accordingly, it has been considered that the variations of various materials relative to temperature change are not same, thus the present invention mainly use different materials of lens elements to achieving the balance relative to temperature change among the lens elements, and the sensitivity of the lenses relative to the temperature can be reduced. Furthermore, the development of a small lens, and the high optical performance at the periphery of the image field can be achieved.

In FIG. 2, the three-piece construction of photographic lens of the present invention has an incident angle of 20 degrees in that light is focused on the image face through the first lens element 10 of the positive optical performance, the second lens element 20 of the negative optical performance and the third lens element 30 of the positive optical performance. Thus, the brightness attenuation in the periphery of the lens of the present invention is lower than that of the conventional short focal length photographic lens, thereby to reducing several ill effects of the conventional lens, such as, for example, the shading effect on the image face and the vignetting phenomenon.

The photographic lens of the present invention is mainly used in a small digital image pickup device with sensitive element 40 adjacent to the image side. Light on the object side can be focused on the image side through the lens elements 10, 20, 30 and the sensitive element 40, and the light signal can be transformed into a electronic signal. The aspherical surfaces have a shape that is defined by the following feature of the three lens elements 10, 20, 30:

$$\frac{F1}{I1} ≅ 1.795$$

$$\begin{matrix}\frac{F1}{f1} ≅ 0.786 ; \\ \frac{F1}{f2} ≅ 0.051 ; \\ \frac{F1}{f3} ≅ 0.157\end{matrix}$$

where
1.49<Nd<1.59; 29<Vd<58;
F1 is an effective focal length;
f1 is a focal length of the first lens element 10;
f2 is a focal length of the second lens element 20;
f3 is a focal length of the third lens element 30; and
I1 is a maximum image height.

Table 2 below lists the surface number #, in order from the object side, the radius of curvature R (mm) near the optical axis of each surface, the on-axis distance D (mm) between surfaces, and the index of refraction Nd and Abbe number Vd of the optical material of the lens elements.

TABLE 2

| # | R | D | Nd/Vd |
|---|---|---|---|
| 11 | 1.299232 | 0.963109 | 1.50176/57.44 |
| 12 | 1.821011 | 0.248195 | |
| 21 | 2.122731 | 0.675322 | 1.57156/29.91 |
| 22 | 1.812535 | 0.642917 | |
| 31 | 5.226811 | 1.46537 | 1.51512/57.15 |
| 32 | 7.219328 | 0.251163 | |

Aspherical Surface 11:

| | |
|---|---|
| Conic: | 0.3735142 |
| Coeff on r 4: | −0.029144862 |
| Coeff on r 6: | 0.0039218234 |
| Coeff on r 8: | −0.0082328557 |
| Coeff on r 10: | −0.019440625 |

Aspherical surface 12:

| | |
|---|---|
| Conic: | 3.065972 |
| Coeff on r 4: | −0.08818095 |
| Coeff on r 6: | −0.0017445907 |
| Coeff on r 8: | 0.02090908 |
| Coeff on r 10: | −0.086345616 |

Aspherical Surface 21:

| | |
|---|---|
| Conic: | 1.501935 |
| Coeff on r 4: | 0.11218646 |
| Coeff on r 6: | 0.0039459153 |
| Coeff on r 8: | 0.0153102 |
| Coeff on r 10: | 0.079781346 |

Aspherical Surface 22:

| | |
|---|---|
| Conic: | −1.213018 |
| Coeff on r 4: | −0.035867 |
| Coeff on r 6: | −0.00030537106 |
| Coeff on r 8: | −0.010148304 |
| Coeff on r 10: | 0.0051989105 |

Aspherical Surface 31:

| | |
|---|---|
| Conic: | −40.03911 |
| Coeff on r 4: | −0.019126 |
| Coeff on r 6: | −0.000522019 |
| Coeff on r 8: | 0.00018152707 |
| Coeff on r 10: | 0.0001143012 |

Aspherical Surface 32:

| | |
|---|---|
| Conic: | 1.427486 |
| Coeff on r 4: | −0.029121111 |
| Coeff on r 6: | −0.0029079381 |
| Coeff on r 8: | −0.000133563 |
| Coeff on r 10: | 6.549131e−006 |

Further, FIGS. 2A-2G show aberrations of the photographic lens of the present invention, with FIG. 2A showing the longitudinal aberration, FIG. 2B showing the lateral color, FIG. 2C showing the curvature field, FIG. 2D showing the distortion, FIG. 2E showing the relative illumination, FIG. 2F showing the polychromatic diffraction MTF, and FIG. 2G showing the polychromatic diffraction through focus MTF, accordingly.

The photographic lens with fixed focal length can be adapted for small electronic devices, such as, for example, a digital camera, the video device of a personal computer, a personal digital assistant, and a portable telephone. By such a construction, various aberrations are favorably corrected and optical performance is improved compared to that of a conventional photographic lens formed of only two lens elements.

To sum up, the present invention provides a portable electronic device, the objects and advantages are summarized below:

1. The photographic lens with fixed focal length of the present invention can reduce the incident angle of light through the lens elements to an image face, and reduce the brightness attenuation of the periphery of the lens due to the first lens element 10 of the positive optical performance, the second lens element 20 of the negative optical performance and the third lens element 30 of the positive optical performance.

2. The photographic lens with fixed focal length of the present invention can reduce the image variation of the lens element due to temperature change because the first lens element 10 is made of acrylic material, the second lens element 20 of polycarbonate material and the third lens element 30 of poly-olefin resin (ZEONEX) material.

There has thus been described a new, novel and heretofore unobvious photographic lens with fixed focal length which eliminates the aforesaid problem in the prior art. Furthermore, those skilled in the art will readily appreciate that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A photographic lens with fixed focal length, the photographic lens comprising, in order from an object side to an image side:
a first lens element having a positive optical performance and made of an acrylic material;
a second lens element having a negative optical performance and made of a polycarbonate material; and
a third lens element having a positive optical performance and made of a poly-olefin resin (ZEONEX) material.

2. The photographic lens of claim 1, further comprising a distance smaller than about 5.3 mm between the object side surface of the first lens element and the image side.

3. A digital image pickup device comprising, in order from an object side to an image side:
a first lens element having a positive optical performance and made of an acrylic material;
a second lens element having a negative optical performance and made of a polycarbonate material;
a third lens element having a positive optical performance and made of a poly-olefin resin (ZEONEX) material; and
a sensitive element adjacent to the image side.

4. The digital image pickup device of claim 3, wherein the sensitive element is a complementary metal-oxide semiconductor (CMOS).
